(19) United States
(12) Patent Application Publication
(10) Pub. No.: US 2009/0296433 A1
(43) Pub. Date: Dec. 3, 2009

(54) Circuit and topology for very high reliability power electronics system

(75) Inventors: Christof Martin Sihler, Hallbergnoos (DE); Robert Roesner, Bayem (DE)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/154,975

(22) Filed: May 29, 2008

(51) Int. Cl. H02J 1/00; H02M 7/00

(52) U.S. Cl. 363/65; 363/123

(57) ABSTRACT

A circuit and system topology includes a plurality of controller units configured to provide a high reliability power system. Sub-systems and devices are controlled via the plurality of controller units such that the high reliability power system remains functional, even subsequent to controller unit, sub-system and device failures.

### BACKGROUND

The invention relates generally to power electronics, and more specifically to a circuit and system topology to provide a high reliability power system.

Power electronic systems in the megawatt range generally consist of a large number of power and control components. Redundancy concepts, other than ruggedizing the components, have typically been employed to improve the reliability of these power electronic systems. One of the most prevalent examples of redundant topologies is the series connection of n+1 or more components such as thyristors. This series connection technique typically limits the redundancy to power semiconductors, as the control system itself, and especially the interface between the controls and the power semiconductor(s) is not redundant.

The risk of non-redundant interface failure(s) between the control system and the power semiconductors, although acceptable for standard industrial applications, is not acceptable for sub-sea power conversion systems. This is because the demands in terms of reliability for sub-sea power conversion systems such as oil and/or gas industry sub-sea installations are much higher. Necessary interventions in case of failure are much more demanding in terms of time and cost for sub-sea power conversion systems.

Redundancies in sub-sea power converters, for example, are a must have since the use of spare parts commonly employed in other applications is not economical. In such sub-sea applications, spare units that are to be installed after years of storage must be tested under operating conditions closely matching the sub-sea operating conditions.

One option to improve system reliability would be to install an additional power electronic unit. The costs associated with sub-sea power electronics typically does not represent more than about 20% of the total cost of a sub-sea power conversion unit. Passive components require most of the space of a sub-sea power conversion unit. A failure of these passive components is very unlikely when properly designed. Therefore, it may be attractive to install a spare power electronics and control unit in each marinized sub-sea conversion unit. The spare unit would not contribute to operation losses, could be tested from time to time, and could take over the controlled supply of the load without relevant system interruption time.

In case afore mentioned in not viable solution, another option would be to design a system with no single point of failure. It would be both advantageous and beneficial in view of the foregoing, to provide a circuit/system for eliminating any single point of failure associated with a power converter/power electronics system, and that can be employed with almost any known power electronics topologies. It would be further advantageous if the circuit/system could fit easily within existing AC/DC converter topologies, DC/AC converter topologies, or DC/DC converter topologies.

### Brief Description

Briefly, in accordance with one embodiment, a power electronics system comprises:

a plurality of substantially identical semiconductor switching devices connected in series to provide a high reliability switch, each semiconductor switching device being driven via a corresponding gate drive unit having a voting unit integrated therein; and

a plurality of controller units, each controller unit configured to generate a full set of output signals, each output signal in communication with a respective integrated voting and gate drive unit of a single semiconductor switching device such that the corresponding semiconductor switching device is controlled via a voting result of the plurality of controller units.

According to another embodiment, a power electronics system comprises:

a plurality of substantially identical groups of power electronics, each group being controlled via a corresponding control unit, wherein each control unit is capable of also controlling one or more different groups of power electronics in the event of one or more different power electronics group control unit failures such that each group of power electronics remains operational subsequent to failure of its corresponding control unit.

According to yet another embodiment, a power electronics system comprises:

one or a plurality of substantially identical groups of power switching devices, each group of power switching devices being controlled via a corresponding group of gate drive units and voting units; and

one or a plurality of controller units, each controller unit configured to generate a plurality of groups of output signals, each group of output signals corresponding to a single group of gate drive units and corresponding voting units such that each group of power switching devices is controlled via a group of output signals associated with each of the controller units.

According to still another embodiment, a power electronics system comprises:

a plurality of power electronics sub-systems, each sub-system being responsive to a corresponding gate drive unit and voting unit; and

a plurality of controller units, each controller unit configured to generate a plurality of output signals, each output signal corresponding to a single gate drive unit and corresponding voting unit such that each sub-system is controlled via a corresponding output signal associated with each of the controller units.

According to still another embodiment, a power electronics system comprising a plurality of power converter drive control units configured to selectively drive a plurality of redundant power converters, each control unit comprising a plurality of outputs configured to provide a desired level of power converter drive redundancy such that each power converter remains operational subsequent to failure of at least one corresponding power converter drive control unit.

According to still another embodiment, a power electronics system comprises a plurality of sub-sea power electronics control units configured to selectively drive a plurality of redundant sub-sea power electronics modules, each control unit comprising a plurality of outputs configured to provide a desired level of sub-sea power electronics module redundancy such that each sub-sea power electronics module remains operational subsequent to failure of at least one corresponding sub-sea power electronics module control unit.

According to still another embodiment, a power electronics system comprises a plurality of redundant sub-sea power electronics sub-systems configured to selectively deliver power to a sub-sea load such that the sub-sea load continues to receive power from at least one sub-sea power electronics sub-system subsequent to faults or shutdowns associated with at least one of the sub-sea power electronics sub-systems.

According to still another embodiment, a power electronics system comprises a plurality of redundant sub-sea power electronics sub-systems, each sub-system comprising a plurality of passive devices and a plurality of substantially identical active devices, wherein the power electronics system is configured to selectively deliver power to a sub-sea load such that the sub-sea load continues to receive power from at least one sub-sea power electronics sub-system subsequent to failure of one or more of the substantially identical active devices so long as at least one sub-system remains operational.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a circuit and system topology for a high power electronics system, according to one embodiment of the invention;

FIG. 2 illustrates an example implementation of a standard 2-level phase leg with no single point of failure;

FIG. 3 illustrates a circuit and system topology for a high power electronics system, according to yet another embodiment of the invention;

FIG. 4 illustrates one example embodiment of a DC/DC converter depicting series connected devices; and

FIG. 5 is a simplified representation of a DC/AC inverter system driving individual subsea loads according to one embodiment of the invention.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

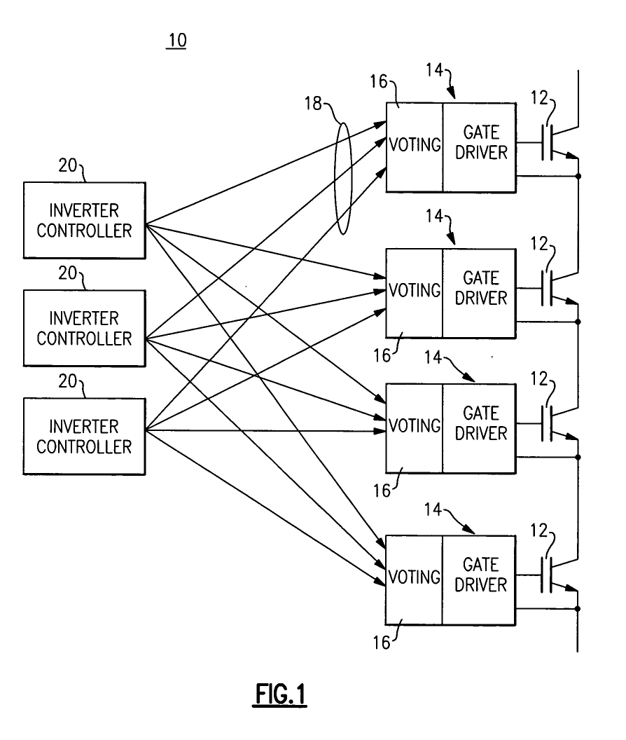

FIG. 1 illustrates a circuit and system topology for a high power electronics system with no single point of failure which is used as a basic building block for many different embodiments. The high power electronics system 10 serves as a single switch function and may be employed in almost every known power electronics topology. It includes a plurality (n+1) of substantially identical high power switching devices 12 such as, without limitation, power semiconductors connected in a series configuration to provide a desired level of switch redundancy such that the switch will continue to function following a short circuit failure mode of one or more of the switching devices 12. The power semiconductors can be, without limitation, IGBT or IGCT or thyristor devices.

The high power electronics system 10 provides a desired level of reliability/availability by extending the foregoing redundancy features also to the entire system. While a standard gate drive unit has only a single input that is used to control its output state, the high power electronics system 10 gate drive units 14 each have a corresponding voting unit 16. Each voting unit 16 has a plurality of inputs 18. Each voting unit input 18 is driven by a corresponding control unit 20. Each control unit 20 is configured to provide inputs to additional voting units 16 in the unlikely event of one or more control unit failures. Each voting unit can employ, for example, XOR logic that is integrated with the switching device 12 gate drive unit 14.

Although only n=3 control units 20 are shown, other embodiments can just as easily be employed that utilize any desired number n of control units 20 and corresponding voting units 18 that are configured with the requisite number of inputs corresponding to a desired number n of control units 20.

The high power electronics system 10 therefore extends the redundancy features also to other portions of the system 10 beyond just the high power switching devices 12. The gate drive units 14 and the voting units 16 are made redundant via the corresponding power semiconductor 12; and redundant gate drive control units 20 are configured to provide redundant input signals to each voting unit 16.

According to one embodiment, a particular high power switching device 12 is turned on if any two or more voting inputs 18 are commanding an on-state for a corresponding voting unit 16. The circuit and system topology depicted in FIG. 1 therefore eliminates any single point of failure including the switching devices 12 and all corresponding control 20 and drive units 14 and voting units 16.

The short circuit failure mode feature of the power device 12 is a passive redundancy concept since there is no requirement for any failure detection and/or isolation scheme. Any failed device remains in the circuit for the entire useful life of the system 10. According to one embodiment, the high power electronics system 10 is a marinized design for subsea applications.

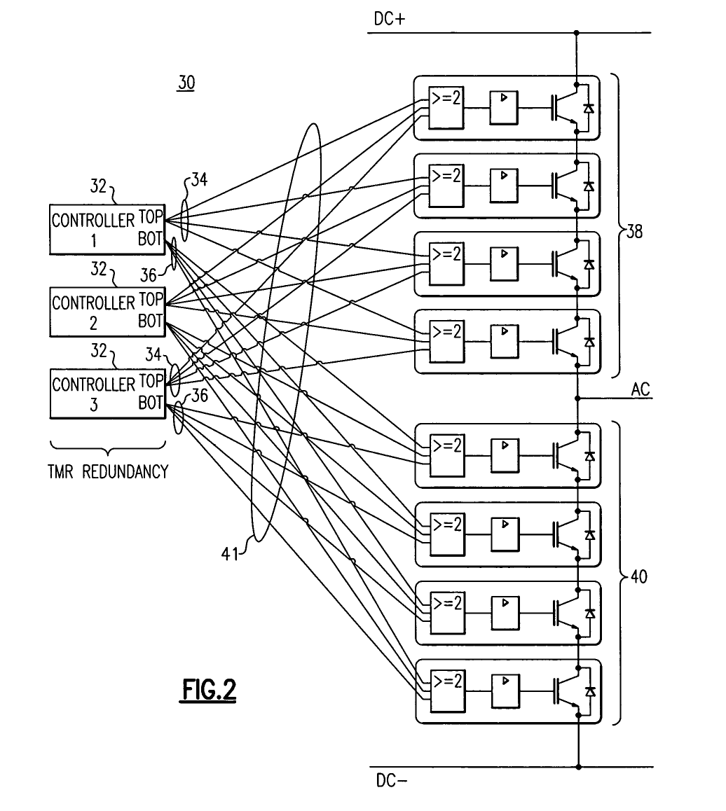

FIG. 2 illustrates a circuit and system topology for a high power electronics system 30, according to another embodiment of the invention. The high power electronics system 30 employs a plurality of redundant front end controllers 32. Each front end controller 32 is configured with a plurality of output groups 34, 36. Output group 34 is configured to control one group of switching devices 38 including the corresponding voting and gate drive units. Output group 36 is configured to control another group of switching devices 40 including the corresponding voting and gate drive units, such as described above. The circuit and system topology depicted in FIG. 2 therefore provides a desired level of device redundancy such that the high power electronics system 30 will continue to operate, regardless of whether a particular controller 32 fails, or whether a failure occurs within a particular group of switching devices 38, 40 or an interconnection 41 failure.

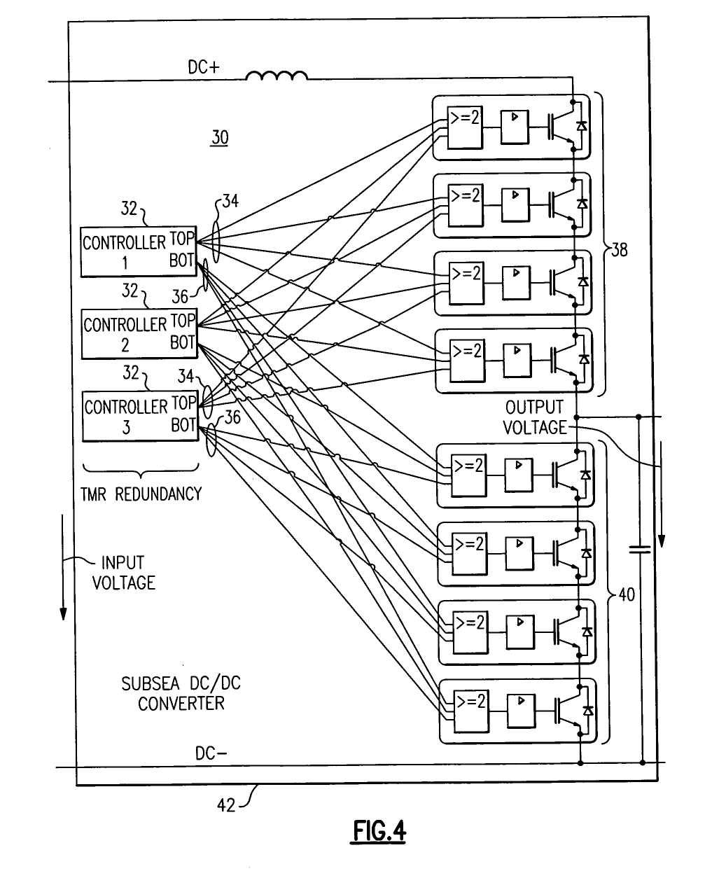

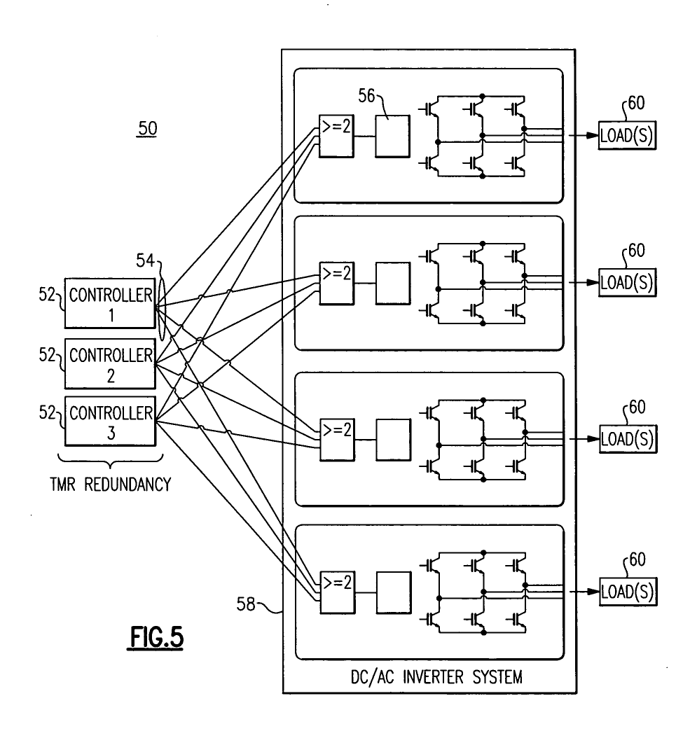

According to some embodiments, the high power electronics system 30 comprises groups of series connected devices 38, 40 in a subsea DC/DC converter 42 such as depicted in FIG. 4, or one or a multiple of DC to AC inverter modules 58 supplying one or a multiple of loads 60 such as depicted in FIG. 5.

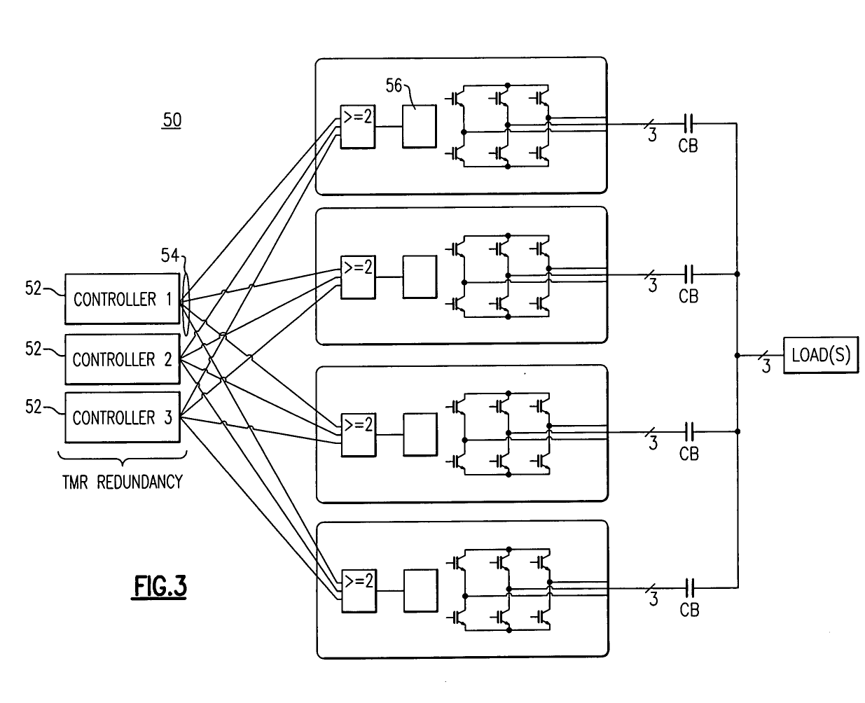

FIG. 3 illustrates a circuit and system topology for a high power electronics system 50, according to yet another embodiment of the invention. The high power electronics system 50 employs a plurality of redundant front end controllers 52. Each front end controller 52 is configured with a plurality of outputs 54 in which each controller output 54 operates to supply a voting unit input signal, such as described above. Each front end controller is configured to provide all necessary signals to control one or multiple two or three phase DC/AC converter. The circuit and system topology depicted in FIG. 3 therefore provides a desired level of device redundancy such that the high power electronics system 50 will continue to operate, regardless of whether a particular controller 52 fails, or whether a particular bridge circuit 56 fails. According to one embodiment, the circuit and system topology depicted in FIG. 3 comprises an inverter system driving one or more subsea loads.

In summary explanation, a high reliability power electronics system has been described that provides a desired level of system and/or device redundancy in a simple and more compact manner than other known systems. The high reliability power electronics system is particularly useful to achieve a desired level of reliability for sub-sea applications in which reliability is a key factor and the cost of power electronics does not really matter since this cost is typically less than 5% of the total system cost.

Device level redundancy for the high reliability power electronics system can be achieved in a simple and more compact way than in other known applications because the gate signals of all series connected devices are identical. System redundancies in one embodiment relate only to active components since passive components are not as likely to fail, are too heavy, and consume excessive space.

A sub-sea application using the principles described herein may, for example, employ only active component redundancy allowing a system to be remotely configured subsequent to a fault and/or shutdown such that a restart is possible and operation can continue using different active but the same passive devices.

Although particular embodiments described above enable continued operation in the event of either a device or control unit failure, redundant topologies can also be configured using the principles described herein to enable continued operation of a complete subsystem such as a power converter, subsequent to a subsystem failure or shutdown. Such a topology may, for example, switch off the failed subsystem and enable operation of a redundant subsystem that employs a different set of active devices but continues to utilize the same set of passive devices, including without limitation, capacitors, inductors, transformers, and the like. Continued use of the existing passive devices will ensure that minimum size and weight constraints are maintained.

The embodiments described above are particularly useful to the elimination of the need to maintain spare unit testing requirements. Because spare units must be tested under operating conditions as close as possible to the sub-sea operating conditions, keeping additional spares requires a major effort, regardless of whether such spares are to be installed on a beach once a fault has occurred, or whether such spares are associated with a permanently installed test station, since the tests would require a representative onshore motor load connected to a generator with braking resistors.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A power electronics system comprising:
a plurality of substantially identical groups of power electronics, each group being controlled via one or multiple corresponding control units, wherein each control unit is capable of also controlling one or more different groups of power electronics in the event of one or more different power electronics group control unit failures such that each group of power electronics remains operational subsequent to failure of at least one control unit.

2. The power electronics system according to claim 1, wherein the power electronics comprise semiconductor switching devices selected from IGBT devices and IGCT devices and thyristor devices.

3. The power electronics system according to claim 1, configured in a marinized design for subsea applications.

4. The power electronics system according to claim 1, wherein the power electronics are integrated within a subsea DC/DC converter or one or more DC to AC or AC to DC inverter/converter modules.

5. A power electronics system comprising:
a plurality of substantially identical semiconductor switching devices connected in series to provide a high reliability switch, each semiconductor switching device being driven via a corresponding gate drive unit having a voting unit integrated therein; and
a plurality of controller units, each controller unit configured to generate a full set of output signals, each output signal in communication with a respective integrated voting and gate drive unit of a single semiconductor switching device such that the corresponding semiconductor switching device is controlled via a voting result of the plurality of controller units.

6. The power electronics system according to claim 5, wherein the plurality of substantially identical semiconductor switching devices are configured to function as a high reliability switch regardless of whether a short circuit failure occurs in any one or more of the switching devices so long as at least a minimum number of switching devices remains operational.

7. The power electronics system according to claim 6, wherein the plurality of substantially identical semiconductor switching devices are further configured to function as a high reliability switch regardless of whether a failure occurs in any one or more of the controller units so long as at least a minimum number of controller units remains operational.

8. The power electronics system according to claim 5, wherein each semiconductor switching device is selected from IGBT devices and IGCT devices and thyristor devices.

9. The power electronics system according to claim 5, wherein each voting unit is configured to provide a corresponding semiconductor switching device drive signal in response to one or more controller unit output signals.

10. The power electronics system according to claim 5, wherein the plurality of substantially identical semiconductor switching devices, corresponding gate drive units and respective integrated voting units, and plurality of substantially identical controller units are together configured as a sub-sea power electronics system.

11. The power electronics system according to claim 5, configured in a marinized design for subsea applications.

12. The power electronics system according to claim 5, wherein the plurality of substantially identical semiconductor switching devices are integrated within a subsea DC/DC converter or one or more DC to AC inverter modules.

13. A power electronics system comprising:
a plurality of substantially identical groups of power switching devices, each group of power switching devices being controlled via a corresponding group of gate drive units and voting units; and
one or a plurality of controller units, each controller unit configured to generate a plurality of groups of output signals, each group of output signals corresponding to a single group of gate drive units and corresponding voting units such that each group of power switching devices is controlled via a group of output signals associated with each of the controller units.

14. The power electronics system according to claim 13, wherein each group of power switching devices are configured to function as a high reliability converter regardless of whether a failure occurs in any one or more of the corresponding switching devices so long as at least a minimum number of switching devices remains operational within the corresponding group of power switching devices.

15. The power electronics system according to claim 14, wherein each group of power switching devices are further configured to function as a high reliability converter regardless of whether a failure occurs in any one or more of the controller units so long as at least a minimum number of controller units remains operational.

16. The power electronics system according to claim 13, wherein each power switching device is selected from IGBT devices and IGCT devices and thyristor devices.

17. The power electronics system according to claim 13, wherein each voting unit is configured to provide a corresponding power switching device drive signal in response to one or more controller unit output signals.

18. The power electronics system according to claim 13, wherein the plurality of substantially identical power switching devices, corresponding gate drive units and voting units, and plurality of controller units are together configured as a sub-sea power electronics system.

19. The power electronics system according to claim 13, configured in a marinized design for subsea applications.

20. The power electronics system according to claim 13, wherein the plurality of substantially identical semiconductor switching devices are integrated in series fashion within a subsea DC/DC converter or one or more DC to AC or AC to DC inverter/converter modules.

21. A power electronics system comprising:
a plurality of power electronics sub-systems, each sub-system being responsive to a corresponding gate drive unit and voting unit; and
a plurality of controller units, each controller unit configured to generate a plurality of output signals, each output signal corresponding to a single gate drive unit and corresponding voting unit such that each sub-system is controlled via a corresponding output signal associated with each of the controller units.

22. The power electronics system according to claim 21, wherein each sub-system is configured to function regardless of whether a failure occurs in any one or more of the controller units so long as at least a minimum number of controller units remains operational.

23. The power electronics system according to claim 21, wherein each voting unit and corresponding gate drive unit is configured to provide a corresponding power switching device drive signal in response to one or more controller unit output signals.

24. The power electronics system according to claim 21, wherein the plurality of sub-systems, corresponding voting units and gate drive units, and plurality of controller units are together configured as a sub-sea power electronics system.

25. The power electronics system according to claim 21, configured in a marinized design for subsea applications.

26. The power electronics system according to claim 21, wherein each sub-system comprises a plurality of series connected devices in a subsea DC/DC converter or one or more DC to AC or AC to DC inverter/converter modules.

27. The power electronics system according to claim 21, configured as an inverter system supplying one or more subsea loads.

28. A power electronics system comprising a plurality of power converter drive control units configured to selectively drive a plurality of redundant power converters, each control unit comprising a plurality of outputs configured to provide a desired level of power converter drive redundancy such that each power converter remains operational subsequent to failure of at least one corresponding power converter drive control unit.

29. The power electronics system according to claim 28, configured in a marinized design for subsea applications.

30. The power electronics system according to claim 28, wherein each power converter comprises a plurality of series connected devices in a subsea DC/DC converter or one or more DC to AC inverter modules.

31. The power electronics system according to claim 28, configured as an inverter system supplying one or more subsea loads.

32. A power electronics system comprising a plurality of sub-sea power electronics drive control units configured to selectively drive a plurality of redundant sub-sea power electronics modules, each control unit comprising a plurality of outputs configured to provide a desired level of sub-sea power electronics module drive redundancy such that each sub-sea power electronics module remains operational subsequent to failure of at least one corresponding sub-sea power electronics module drive control unit.

33. The power electronics system according to claim 32, configured in a marinized design for subsea applications.

34. The power electronics system according to claim 32, wherein each power electronics module comprises a plurality of series connected devices in a subsea DC/DC converter or one or more DC to AC inverter modules.

35. The power electronics system according to claim 34, configured as an inverter system supplying one or more subsea loads.

36. A power electronics system comprising a plurality of redundant sub-sea power electronics sub-systems configured to selectively deliver power to a sub-sea load such that the sub-sea load continues to receive power from at least one sub-sea power electronics sub-system subsequent to faults or shutdowns associated with at least one of the sub-sea power electronics sub-systems.

37. The power electronics system according to claim 36, configured in a marinized design for subsea applications.

38. The power electronics system according to claim 36, wherein each power electronics sub-system comprises a plurality of series connected devices in a subsea DC/DC converter or one or more DC to AC inverter modules.

39. The power electronics system according to claim 36, configured as an inverter system supplying one or more subsea loads.

40. A power electronics system comprising a plurality of redundant sub-sea power electronics sub-systems, each sub-system comprising a plurality of passive devices and a plurality of substantially identical active devices, wherein the power electronics system is configured to selectively deliver power to a sub-sea load such that the sub-sea load continues to receive power from at least one sub-sea power electronics sub-system subsequent to failure of one or more of the substantially identical active devices so long as at least one sub-system remains operational.

41. The power electronics system according to claim 40, configured in a marinized design for subsea applications.

42. The power electronics system according to claim 40, wherein each subsystem comprises a plurality of series connected devices in a subsea DC/DC converter or one or more DC to AC inverter modules.

43. The power electronics system according to claim 40, configured as an inverter system supplying one or more subsea loads.
